(19) United States
(12) Patent Application Publication
(10) Pub. No.: US 2008/0081631 A1
(43) Pub. Date: Apr. 3, 2008

(54) Method And System For Integrating An NFC Antenna And A BT/WLAN Antenna

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/536,673

(22) Filed: Sep. 29, 2006

(51) Int. Cl. H04Q 7/20

(52) U.S. Cl. 455/452.1

(57) ABSTRACT

Methods and systems for integrating a near field communication (NFC) antenna and a Bluetooth/WLAN/ZigBee antenna are disclosed and may include configuring a first antenna that communicates at least a first RF protocol signal so that the first antenna functions as a ground plane for a second antenna when communicating at least a second RF protocol signal via the second antenna. The first antenna may include an NFC antenna and/or an RFID antenna. The second antenna may include a wireless LAN (WLAN) antenna and/or a Bluetooth antenna. The first RF protocol signal may include a NFC signal and/or a RFID signal, and the second RF protocol signal may include a Bluetooth signal and/or a Wireless LAN (WLAN) signal. The first antenna may receive a third RF protocol signal, which may include an FM signal and/or a digital video broadcast handheld (DVB-H) signal.

### CROSS-REFERENCE TO RELATED APPLICATIONS/INCORPORATION BY REFERENCE

This application also makes reference to:

U.S. application Ser. No. ______ (Attorney Docket No. 17783US01), filed on even date herewith;
U.S. application Ser. No. ______ (Attorney Docket No. 17784US01), filed on even date herewith;
U.S. application Ser. No. ______ (Attorney Docket No. 17785US01), filed on even date herewith;
U.S. application Ser. No. ______ (Attorney Docket No. 17786US01), filed on even date herewith;
U.S. application Ser. No. ______ (Attorney Docket No. 17787US01), filed on even date herewith;
U.S. application Ser. No. ______ (Attorney Docket No. 17788US01), filed on even date herewith;
U.S. application Ser. No. ______ (Attorney Docket No. 17790US01), filed on even date herewith;
U.S. application Ser. No. ______ (Attorney Docket No. 17791US01), filed on even date herewith;
U.S. application Ser. No. ______ (Attorney Docket No. 17792US01), filed on even date herewith;
U.S. application Ser. No. ______ (Attorney Docket No. 17916US01), filed on even date herewith;
U.S. application Ser. No. ______ (Attorney Docket No. 17917US01), filed on even date herewith;
U.S. application Ser. No. ______ (Attorney Docket No. 17918US01), filed on even date herewith;
U.S. application Ser. No. ______ (Attorney Docket No. 17919US01), filed on even date herewith;
U.S. application Ser. No. ______ (Attorney Docket No. 17920US01), filed on even date herewith;
U.S. application Ser. No. ______ (Attorney Docket No. 17921US01), filed on even date herewith;
U.S. application Ser. No. ______ (Attorney Docket No. 17922US01), filed on even date herewith;
U.S. application Ser. No. ______ (Attorney Docket No. 17923US01), filed on even date herewith;
U.S. application Ser. No. ______ (Attorney Docket No. 17924US01), filed on even date herewith;
U.S. application Ser. No. ______ (Attorney Docket No. 17925US01), filed on even date herewith;
U.S. application Ser. No. ______ (Attorney Docket No. 17926US01), filed on even date herewith;
U.S. application Ser. No. ______ (Attorney Docket No. 17927US01), filed on even date herewith;
U.S. application Ser. No. ______ (Attorney Docket No. 17928US01), filed on even date herewith;
U.S. application Ser. No. ______ (Attorney Docket No. 17929US01), filed on even date herewith; and
U.S. application Ser. No. ______ (Attorney Docket No. 17930US01), filed on even date herewith.

The above stated applications are hereby incorporated herein by reference in their entirety.

### FIELD OF THE INVENTION

Certain embodiments of the invention relate to Bluetooth (BT) and near field communication (NFC) technologies. More specifically, certain embodiments of the invention relate to a method and system for integrating an NFC antenna and a BT/WLAN antenna.

### BACKGROUND OF THE INVENTION

Portable electronic devices and wireless devices that support audio applications are becoming increasingly popular and, consequently, there is a growing need to provide a simple and complete solution for audio communications applications. For example, some users may utilize Bluetooth-enabled devices, such as headphones and/or speakers, to allow them to communicate audio data with their wireless handset while freeing to perform other activities. Other users may have portable electronic devices that may enable them to play stored audio content and/or receive audio content via broadcast communication, for example.

Radio frequency identification (RFID) is a data collection technology that enables the storing and remote retrieval of data utilizing devices referred to as RFID tags, or transponders. An RFID tag may comprise a silicon integrated circuit, or chip, and an antenna that enables the RFID tag to receive and respond to radio frequency (RF) queries from an RFID transceiver. The RFID tag may comprise memory, for example a random access memory (RAM) or an electrically erasable programmable read only memory (EEPROM), which enables storage of data. The data may comprise an electronic product code (EPC) that may be utilized to locate an item to which the RFID tag is attached. For example, libraries may attach RFID tags to books to enable the tracking of books that are checked out to library patrons. RFID tags may be integrated into plastic, credit card sized devices referred to as “smart cards.” The RFID tags in smart cards may enable storage of account information that enables the holder of the smart card to purchase goods and services. The smart card, for example, may store a current balance that indicates a monetary value of goods and services that may be purchased with the smart card. The smart card holder may purchase goods and services by holding the smart card in the proximity of an RFID transceiver that retrieves account information from the smart card. The RFID transceiver may, for example, decrease the current balance to reflect purchases and store the updated value in the smart card. The RFID transceiver may also increase the current balance when the user purchases additional monetary value.

Near field communication (NFC) is a communication standard that enables wireless communication devices, such as cellular telephones, SmartPhones, and personal digital assistants (PDAs) to establish peer-to-peer (P2P) networks. NFC may enable electronic devices to exchange data and/or initiate applications automatically when they are brought in close proximity, for example ranging from touching, or 0 cm, to a distance of about 20 cm. NFC may enable downloading of images stored in a digital camera, to a personal computer, or downloading of audio and/or video entertainment to MP3 devices, or downloading of data stored in a SmartPhone to a personal computer, or other wireless device, for example. NFC may be compatible with smart card technologies and may also be utilized to enable purchase of goods and services. RFID applications and NFC applications may utilize a common RF band.

However, integrating the disparate mobility applications and services into a single device may be costly. Some conventional portable electronic device, for example, may utilize separate antennas, hardware, and/or software for the reception, transmission, and/or processing of signals associated with the various mobility applications and services. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges. For example, a handheld device such as a cellphone that incorporates Bluetooth and Wireless LAN may pose certain coexistence problems caused by the close proximity of the Bluetooth and WLAN frequency converters. Furthermore, simultaneous use of a plurality of radios in a handheld communication device may result in significant increases in power consumption. Power being a precious commodity in most wireless mobile devices, combining devices such as a cellular radio, a Bluetooth radio and a WLAN radio requires careful design and implementation in order to minimize battery usage. Additional overhead such as sophisticated power monitoring and power management techniques are required in order to maximize battery life. In addition, the use of a plurality of radios in a wireless communication device may result in significant implementation costs since each radio needs a transmit/receive antenna, which has to be implemented within a limited space inside the wireless communication device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for integrating an NFC antenna and a BT/WLAN antenna, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary NFC transmitter that communicates with handheld devices that utilize a single chip with integrated Bluetooth and NFC radios via an integrated antenna, in accordance with an embodiment of the invention.

FIG. 2 is a block diagram of an exemplary system that supports Bluetooth and NFC communication via an integrated antenna, in accordance with an embodiment of the invention.

FIG. 3 is a block diagram of another exemplary system that supports Bluetooth and NFC communication via an integrated antenna, in accordance with an embodiment of the invention.

FIG. 4 is a block diagram of an exemplary BT/WLAN/NFC/RFID transceiver module using an integrated antenna, in accordance with an embodiment of the invention.

FIG. 5 is a block diagram of an integrated NFC and BT/WLAN antenna, in accordance with an embodiment of the invention.

FIG. 6 is a flow diagram that illustrates an exemplary method for communicating wireless signals via an integrated frequency conversion in accordance with an embodiment of the invention.

### DETAILED DESCRIPTION OF THE INVENTION

Certain embodiments of the invention may be found in a method and system for integrating a near field communication (NFC) antenna and a Bluetooth/Wireless Local Area Network (WLAN) antenna. Certain embodiments of the invention may comprise configuring a first antenna that communicates at least a first RF protocol signal so that the first antenna functions as a ground plane for a second antenna when communicating at least a second RF protocol signal via the second antenna. The first antenna may comprise an NFC antenna and/or an RFID antenna. The second antenna may comprise a wireless LAN (WLAN) antenna and/or a Bluetooth antenna. The first RF protocol signal may comprise a NFC signal and/or a RFID signal, and the second RF protocol signal may comprise a Bluetooth signal and/or a Wireless LAN (WLAN) signal. The first antenna may receive a third RF protocol signal, which may comprise an FM signal and/or a digital video broadcast handheld (DVB-H) signal. If the third RF protocol signal comprises a DVB-H signal, a length of the first antenna may be reduced by, for example, one-half via a grounding circuit. The grounding circuit may comprise a switch and/or a grounded L-C circuit.

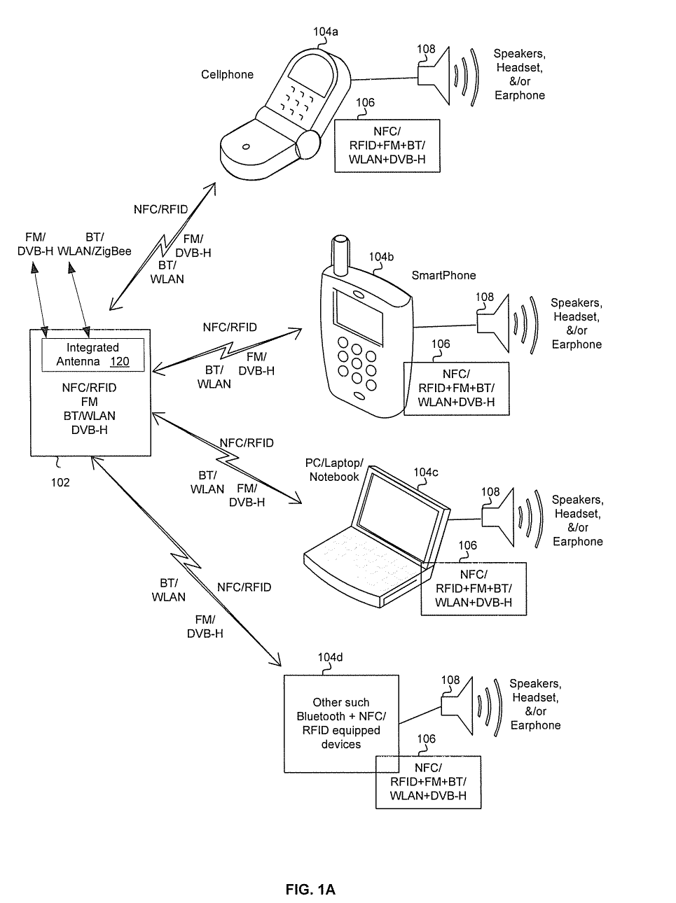

FIG. 1A is a block diagram of an exemplary NFC transmitter that communicates with handheld devices that utilize a single chip with integrated Bluetooth and NFC radios via an integrated antenna, in accordance with an embodiment of the invention. Referring to FIG. 1A, there is shown a wireless device 102, a cellular phone 104a, a smart phone 104b, a computer 104c, and an exemplary NFC/RFID and Bluetooth-equipped device 104d. The wireless device 102 may be implemented as part of a radio station or other broadcasting device, for example. Furthermore, the wireless device may be adapted to receive or transmit different types of signals, such as NFC signals, RFID signals, FM signals, Bluetooth signals, WLAN signals, and/or DVB-H signals. Each of the cellular phone 104a, the smart phone 104b, the computer 104c, and the exemplary NFC and Bluetooth-equipped device 104d may comprise a single chip 106 with integrated Bluetooth/WLAN/ZigBee and NFC/RFID radios for supporting NFC/RFID, Bluetooth/WLAN/ZigBee, and FM/DVB-H data communications. The wireless device 102 may enable communication of NFC/RFID, BT/WLAN/ZIGBEE, and/or FM/DVB-H data to the devices shown in FIG. 1 by utilizing the single chip 106. Each of the devices in FIG. 1 may comprise and/or may be communicatively coupled to a listening device 108 such as a speaker, a headset, or an earphone, for example.

In one embodiment of the invention, the wireless device 102 may comprise a single integrated antenna 120. The integrated antenna 120 may comprise a loop antenna, such as an RFID loop antenna. The RFID loop antenna may be used for communicating NFC/RFID signals. In another embodiment of the invention, the integrated antenna 120 may also comprise a BT/WLAN/ZIGBEE antenna, which may be used for communicating Bluetooth and/or wireless LAN (WLAN) signals. In instances when the BT/WLAN/ZIGBEE is used to transmit BT or WLAN signals, the NFC transmitter may utilize the NFC/RFID loop antenna portion as a ground plane for the BT/WLAN/ZIGBEE antenna. In this regard, a single integrated antenna may be used for communicating different types of signals, such as BT, WLAN, NFC and/or RFID signals, while improving antenna transmit and receive characteristics by using the NFC/RFID antenna as a ground plane for the BT/WLAN/ZIGBEE antenna.

The cellular phone 104a may be enabled to receive an NFC transmission signal from the NFC transmitter 102. The user of the cellular phone 104a may then listen to the transmission via the listening device 108. The cellular phone 104a may comprise a “one-touch” programming feature that enables access to specifically desired broadcasts, like weather, sports, stock quotes, or news, for example. The smart phone 104b may be enabled to receive an NFC transmission signal from the NFC transmitter 102. The user of the smart phone 104b may then listen to the transmission via the listening device 108.

The computer 104c may be any one of a desktop, laptop, notebook, tablet, and a PDA, for example. The computer 104c may be enabled to receive an NFC transmission signal from the NFC transmitter 102. The user of the computer 104c may then listen to the transmission via the listening device 108. The computer 104c may comprise software menus that enable configuration of listening options and enable quick access to favorite options, for example. While a cellular phone, a smart phone, computing devices, and other devices have been shown in FIG. 1A, the single chip 106 may be utilized in a plurality of other devices and/or systems that receive and use Bluetooth and/or NFC signals. In one embodiment of the invention, the single chip Bluetooth and NFC radio may be utilized in a system comprising a WLAN radio.

In another embodiment of the invention, the cellular phone 104a, the smart phone 104b, the computer 104c, and the exemplary NFC and Bluetooth-equipped device 104d may all utilize an integrated antenna, such as antenna 120, to communicate wireless signals using the NFC and BT/WLAN/ZIGBEE chip 106.

Near Field Communication (NFC) is a low speed communication protocol. NFC may be used, for example, to set up a Bluetooth communication link between two computers by simply touching the two computers to open a connection to exchange the parameters of the Bluetooth communication. A Bluetooth communication session may be established as a second step of this procedure without any human interference. Once the communication session is established, the computers may be moved away from each other but the communication may continue via the Bluetooth communication session that was established previously. The same procedure may be used to establish a wireless link, for example, Bluetooth, or Wi-Fi, between two computers or consumer electronics devices like TVs, laptop computers, PDAs, mobile phones, and/or smartphones.

The NFC protocol is based on a wireless interface in which there are always two parties to the communication. Accordingly, the protocol may be referred to as a peer-to-peer communication protocol. The NFC protocol may be utilized to establish wireless network connections between network appliances and consumer electronics devices. The NFC interfaces operate in the unregulated RF band of 13.56 MHz. This means that no restrictions are applied and no licenses are required for the use of NFC devices in this RF band. Of course, each country imposes certain limitations on the electromagnetic emissions in this RF band. These limitations mean that, in practice, the distance at which the devices may connect with each other is restricted and this distance may vary from country to country. Operating distances of 0˜20 cm may be generally utilized for NFC. The bit rate=(Dxfc)/128, where D=2^{N} and N=0 to 6. Data may be Manchester encoded using ASK modulation.

As is often the case with the devices sharing a single RF band, the communication is half-duplex. The devices may implement a “listen before talk” policy, in which a device first listens on the carrier frequency and start transmitting a signal only if no other transmitting device is detected. The NFC protocol distinguishes between an initiator and a target of the communication. Any device may be either an Initiator or a target. The initiator is the device that initiates and controls the exchange of data. The target is the device that answers the request from the Initiator. The NFC protocol also distinguishes between two modes of operation, namely, an active mode and a passive mode. NFC compliant devices may support both communication modes. In the active mode of communication, the initiator and target devices may generate their own RF field to carry the data. In the passive mode of communication, only one device may generate the RF field while the other device uses load modulation to transfer the data. The NFC protocol specifies that the Initiator is the device responsible to generate the RF field.

Communication using NFC protocol is desirable since it provides some features not found in other general-purpose protocols. First of all, it is a very short-range protocol. It supports communication at distances measured in centimeters. The devices have to be literally almost touched to establish the link between them. This has some important consequences. The devices may rely on the protocol to be inherently secured since the devices must be placed very close to each other. It is easy to control whether the two devices communicate by simply placing them next to each other or keeping them apart. The procedure utilized for establishing the protocol is inherently familiar to people, since if it is desirable to have two devices communicate, the two devices may be brought with range, of the order of centimeters, of each other. This allows for the establishment of a network connection between the devices to be completely automated and transparent. The whole process may appear as though the devices recognize each other by touch and connect to each other once touching occurs.

Another important feature of this protocol is the support for the passive mode of communication. This is very important for the battery-powered devices since they have to place conservation of the energy as the first priority. The protocol allows such a device, like a mobile phone, to operate in a power-saving mode, namely, the passive mode of NFC. This mode does not require both devices to generate the RF field and allows the complete communication to be powered from one side only. Of course, the device itself will still need to be powered internally but it does not have to “waste” the battery on powering the RF communication interface.

Also, the protocol may be used easily in conjunction with other protocols to select devices and automate connection set-up. As was demonstrated in the examples of use above, the parameters of other wireless protocols may be exchanged allowing for automated set-up of other, snf longer-range connections. The difficulty in using longer-range protocols like Bluetooth or Wireless Ethernet is in selecting the correct device out of the multitude of devices in the range and providing the right parameters for the connection. Using NFC, the whole procedure is simplified to a mere touch of one device to another.

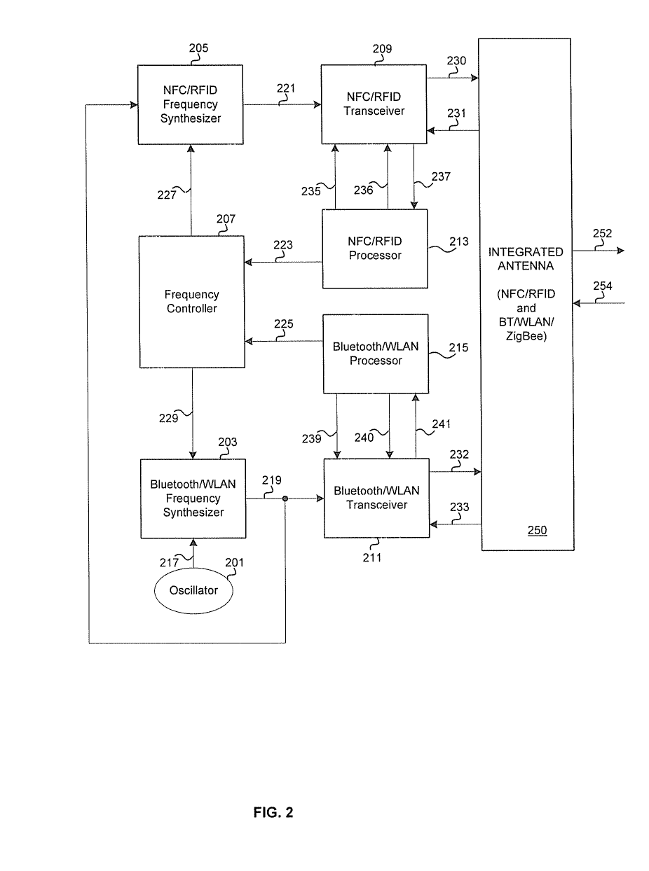

FIG. 2 is a block diagram of an exemplary system that supports Bluetooth and NFC communication via an integrated antenna, in accordance with an embodiment of the invention. The system comprises an oscillator 201, a Bluetooth/WLAN/ZigBee frequency synthesizer 203, an NFC/RFID frequency synthesizer 205, a frequency controller 207, an NFC/RFID frequency transceiver 209, Bluetooth/WLAN/ZigBee frequency transceiver 211, an NFC/RFID processor 213, a Bluetooth/WLAN/ZigBee processor 215, and an integrated antenna 250.

The oscillator 201 may be a temperature controlled crystal oscillator. The oscillator 201 may enable generation of a clock frequency 217 (e.g. 13 MHz, 26 MHz, 24.3 MHz) that may drive the Bluetooth/WLAN/ZigBee frequency synthesizer 203. The Bluetooth/WLAN/ZigBee frequency synthesizer 203 may be a radio frequency generator that generates a Bluetooth/WLAN/ZigBee carrier frequency 219. For example, the Bluetooth/WLAN/ZigBee carrier frequency 219 may be specified by the following relationship:

2.4 GHz+BT_{chan}_{_{—}}ₙᵤₘ×1 MHz,

where BT_{chan}_{_{—}}ₙᵤₘ is the channel number for the Bluetooth communication. It should noted that the IF may not be fixed or a direct conversion but it can be any frequency.

The Bluetooth/WLAN/ZigBee frequency synthesizer 203 may generate a Bluetooth/WLAN/ZigBee carrier frequency 219, which may be used as an input to the Bluetooth/WLAN/ZigBee frequency transceiver 211. The Bluetooth/WLAN/ZigBee transceiver 211 may use the Bluetooth/WLAN/ZigBee carrier frequency 219 to up-convert a baseband Bluetooth/WLAN/ZigBee transmit signal 240, thereby generating an output RF Bluetooth/WLAN/ZigBee transmit signal 232. The Bluetooth/WLAN/ZigBee transceiver 211 may also use the Bluetooth/WLAN/ZigBee carrier frequency 219 to down-convert an input RF Bluetooth/WLAN/ZigBee receive signal 233, thereby generating an output baseband Bluetooth/WLAN/ZigBee receive signal 241.

In accordance with an embodiment of the invention, the Bluetooth/WLAN/ZigBee processor 215 may generate a control signal 239 that controls time division multiplexing of transmitting and receiving by the Bluetooth/WLAN/ZigBee transceiver 211. The Bluetooth/WLAN/ZigBee processor 215 may send a BT_{chan}_{_{—}}ₙᵤₘ via signal 225 to the Bluetooth/WLAN/ZigBee frequency controller 307, which may be utilized to control operation of the Bluetooth/WLAN/ZigBee frequency synthesizer 203. The frequency controller 207 may utilize the BT_{chan}_{_{—}}ₙᵤₘ signal 225 to control the Bluetooth/WLAN/ZigBee frequency synthesizer 203 during adaptive frequency hopping (AFH).

The NFC/RFID frequency synthesizer 205 may generate an NFC/RFID carrier frequency 221 (13.56 MHz) based on the Bluetooth/WLAN/ZigBee carrier frequency 219, the latter of which may be generated by the Bluetooth/WLAN/ZigBee frequency synthesizer 203. The NFC/RFID frequency transceiver 209 may use the generated NFC/RFID carrier frequency 221 to up-convert an input baseband NFC/RFID transmit signal 236, thereby generating an output RF NFC/RFID transmit signal 230. The NFC/RFID transceiver 209 may also use the NFC/RFID carrier frequency 221 to down-convert an input RF NFC/RFID receive signal 231, thereby generating an output baseband NFC/RFID receive signal 237. The NFC/RFID processor 213 may generate a control signal 235 that controls time division multiplexing of transmission and reception by the NFC/RFID transceiver.

The NFC/RFID frequency synthesizer 205 may enable generation of the NFC/RFID carrier frequency 221 by dividing the Bluetooth/WLAN/ZigBee carrier frequency 219 by a divisor 227, the latter of which may be supplied by the frequency controller 207. The frequency controller 207 may generate the divisor 227 as a ratio of the Bluetooth/WLAN/ZigBee carrier frequency 219 (2.4 GHz+BT_{chan}_{_{—}}ₙᵤₘ×1 MHz) to the NFC/RFID carrier frequency 221 (13.56 MHz).

The integrated antenna 250 may comprise a loop antenna, such as an RFID loop antenna. The RFID loop antenna within the integrated antenna 250 may be used for communicating NFC/RFID signals, such as signals 230 and 231. In another embodiment of the invention, the integrated antenna 250 may also comprise a BT/WLAN/ZIGBEE antenna, which may be used for communicating Bluetooth and/or wireless LAN (WLAN) signals, such as signals 232 and 233. In instances when the NFC/RFID transceiver 209 utilizes the BT/WLAN/ZIGBEE antenna portion of the integrated antenna 250 to transmit BT/WLAN/ZIGBEE signals 232, the first antenna, i.e. the NFC/RFID antenna within the integrated antenna 250, may be utilized as a ground plane for the BT/WLAN/ZIGBEE antenna. In this regard, the single integrated antenna 250 may be used for communicating different types of signals, such as BT, WLAN, NFC and/or RFID signals, while improving antenna transmit and receive characteristics by using the NFC/WLAN antenna as a ground plane for the BT/WLAN/ZIGBEE antenna within the integrated antenna 250.

In operation, the RFID loop antenna within the integrated antenna 250 may receive the NFC/RFID transmit signal 230 from the NFC/RF transceiver 209 and may transmit the signal 230 as an output signal 252. In instances when the BT/WLAN/ZIGBEE transceiver 211 is utilized, the BT/WLAN/ZIGBEE antenna within the integrated antenna 250 may receive the BT/WLAN/ZIGBEE transmit signal 232 from the BT/WLAN/ZIGBEE transceiver 211 and may transmit the signal 232 as an output signal 252. During transmission of the BT/WLAN/ZIGBEE output signal 232, the BT/WLAN/ZIGBEE antenna within the integrated antenna 250 may utilize the NFC/RFID loop antenna as a ground plane to increase antenna efficiency.

When the integrated antenna 250 receives a signal 254, it may be determined whether the received signal comprises an NFC/RFID signal or a BT/WLAN/ZIGBEE signal. If the received signal 254 comprises an NFC/RFID signal 231, then signal 231 may be communicated to the NFC/RFID transceiver 209 for processing. Similarly, if the received signal 254 comprises a BT/WLAN/ZIGBEE signal 233, then signal 233 may be communicated to the BT/WLAN/ZIGBEE transceiver 211 for processing.

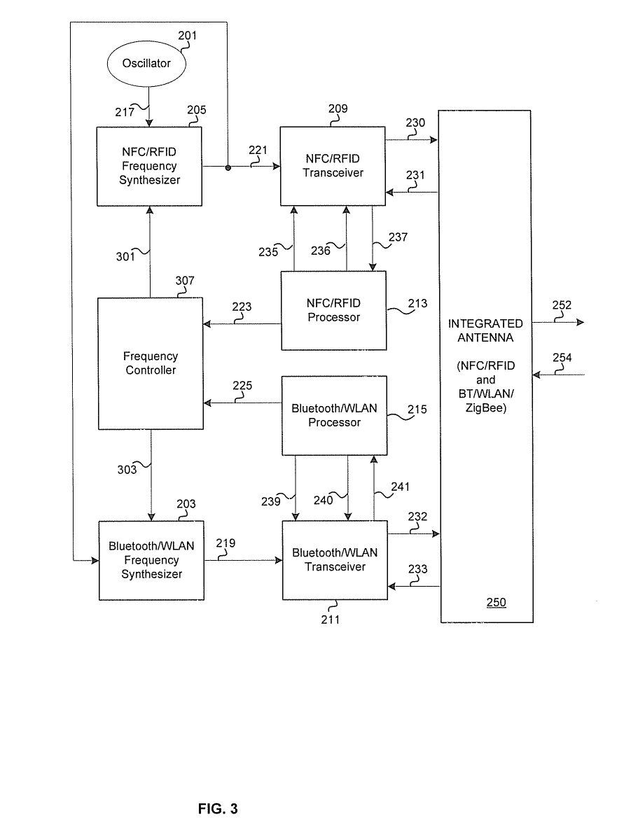

FIG. 3 is a block diagram of another exemplary system that supports Bluetooth and NFC/RFID communication via an integrated antenna, in accordance with an embodiment of the invention. Referring to FIG. 3, there is shown an oscillator 201, a Bluetooth/WLAN/ZigBee frequency synthesizer 203, a NFC/RFID frequency synthesizer 205, a frequency controller 307, an NFC/RFID transceiver 209, Bluetooth/WLAN/ZigBee transceiver 211, a NFC/RFID processor 213, Bluetooth/WLAN/ZigBee processor 215, and an integrated antenna 250. The functionality of the integrated antenna 250 is the same as the functionality of the integrated antenna 250 as described herein above with regard to FIG. 2.

The oscillator 201 may be a temperature controlled crystal oscillator. The oscillator 201 may enable generation of a clock frequency 217 signal, which may be used to drive the NFC/RFID frequency synthesizer 205. The NFC/RFID frequency synthesizer 205 may use the generated clock frequency 217 to generate a NFC/RFID carrier frequency 221, the latter of which may be used by the NFC/RFID transceiver 209 and/or the Bluetooth/WLAN/ZigBee frequency synthesizer 203. The NFC/RFID transceiver 209 may utilize the generated NFC/RFID carrier frequency 221 to up-convert an input baseband NFC/RFID transmit signal 236, thereby generating an output RF NFC/RFID transmit signal 230. The NFC/RFID transceiver 209 may also be used to down-convert an input RF NFC/RFID received signal 231, thereby generating an output baseband NFC/RFID receive signal 237, which may be supplied as in input to the NFC/RFID processor 213. The NFC/RFID processor 213 may generate a control signal 235, which may be utilized to control a time division multiplexing of transmission and reception by the NFC/RFID transceiver 209.

The Bluetooth/WLAN/ZigBee frequency synthesizer 203 may be a radio frequency generator that enables generation of a Bluetooth/WLAN/ZigBee carrier frequency 219 based on the NFC/RFID carrier frequency 221. For example, the Bluetooth/WLAN/ZigBee carrier frequency 219 may be 2.4 GHz+BT_{chan}_{_{—}}ₙᵤₘ×1 MHz, where BT_{chan}_{_{—}}ₙᵤₘ is the channel number for the Bluetooth/WLAN/ZigBee communication. It should noted that the IF may not be fixed or a direct conversion but it can be any frequency.

The Bluetooth/WLAN/ZigBee transceiver 211 may use the Bluetooth/WLAN/ZigBee carrier frequency 219 to up-convert a received baseband Bluetooth/WLAN/ZigBee transmit signal 240, thereby generating an output RF Bluetooth/WLAN/ZigBee transmit signal 232. The Bluetooth/WLAN/ZigBee frequency transceiver 211 may also use the Bluetooth/WLAN/ZigBee carrier frequency 219 to down-convert a received RF Bluetooth/WLAN/ZigBee signal 233, thereby generating an output baseband Bluetooth/WLAN/ZigBee signal 241.

In accordance with an embodiment of the invention, the Bluetooth/WLAN/ZigBee processor 215 may generate a control signal 239 the may be utilized to control time division multiplexing of transmission and reception by the Bluetooth/WLAN/ZigBee transceiver 211 and receive. The Bluetooth/WLAN/ZigBee processor 215 may also send a BT_{chan}_{_{—}}ₙᵤₘ from the signal 225 to the frequency controller 307. The frequency controller 307 may utilize the BT_{chan}_{_{—}}ₙᵤₘ signal 225 to control the Bluetooth/WLAN/ZigBee frequency synthesizer 203 during adaptive frequency hopping (AFH).

The Bluetooth/WLAN/ZigBee frequency synthesizer 203 may generate the Bluetooth/WLAN/ZigBee carrier frequency 219 by multiplying the NFC/RFID carrier frequency 221 by a scalar 303 that may be supplied by the frequency controller 307. The NFC/RFID carrier frequency 221 may be generated by the NFC/RFID synthesizer 205. The scalar 303 may be generated in the frequency controller 307. The scalar 303 may be represented as the ratio of the Bluetooth/WLAN/ZigBee carrier frequency 219 (2.4 GHz+BT_{chan}_{_{—}}ₙᵤₘ×1 MHz) to the NFC/RFID carrier frequency 221 (13.56 MHz).

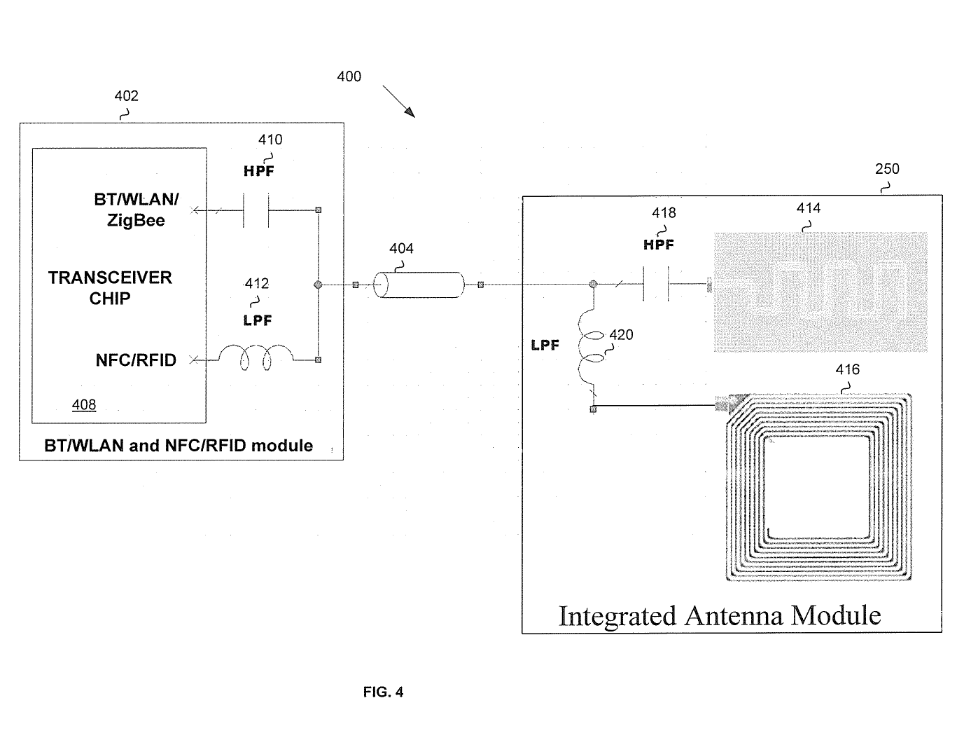

FIG. 4 is a block diagram of an exemplary BT/WLAN/ZIGBEE/NFC/RFID transceiver module using an integrated antenna, in accordance with an embodiment of the invention. Referring to FIG. 4, there is shown a communication system 400. The communication system 400 may comprise a transceiver module 402 and an integrated antenna module 250. The transceiver module 402 and the integrated antenna module 250 may be coupled via a resistor 404.

The transceiver module 402 may comprise a BT/WLAN/ZIGBEE and NFC/RFID transceiver chip 408, which may enable communication of BT/WLAN/ZIGBEE and NFC/RFID signals to and from the integrated antenna module 250. The transceiver module 402 may further comprise a high-pass filter (HPF) 410 and a low-pass filter (LPF) 412. The HPF 410 may comprise, for example, a capacitor, and the LPF 412 may comprise, for example, an inductor. The HPF 410 and the LPF 412 may be coupled to the BT/WLAN/ZIGBEE and NFC/RFID transceiver chip 408 so that BT signals communicated to and from the chip 408 pass through the HPF 410, and NFC/RFID signals communicated to and from chip 408 may pass through the LPF 412.

The integrated antenna module 250 may comprise a BT/WLAN/ZIGBEE antenna 414, an NFC/RFID loop antenna 416, a HPF 418, and a LPF 420. The HPF 418 may comprise, for example, a capacitor, and the LPF 420 may comprise, for example, an inductor. The HPF 418 and the LPF 420 may be coupled to the BT/WLAN/ZIGBEE antenna 414 and the NFC/RFID loop antenna 416, respectively. In this regard, that BT/WLAN/ZIGBEE signals communicated to and from the BT/WLAN/ZIGBEE antenna 414 pass through the HPF 418, and NFC/RFID signals communicated to and from the NFC/RFID antenna 416 pass through the LPF 420. The integrated antenna module 250 may be implemented on a single substrate and may have the same functionalities as the integrated antenna 250 described above with regard to FIGS. 2 and 3. For example, the NFC/RFID antenna 416 may be mounted in close proximity to the BT/WLAN/ZIGBEE antenna 414, so that whenever the BT/WLAN/ZIGBEE antenna 414 communicates BT/WLAN/ZIGBEE signals, the NFC/RFID antenna 416 may function as a ground plane for the BT/WLAN/ZIGBEE antenna 414.

In operation, the BT/WLAN/ZIGBEE and NFC/RFID transceiver chip 408 may generate BT or WLAN signals, which may be high-pass filtered by the HPF 410. The high-pass filtered BT/WLAN/ZIGBEE signals may be communicated via the resistor 404 and the HPF 418 to the BT/WLAN/ZIGBEE antenna 414 for transmission. Similarly, the BT/WLAN/ZIGBEE and NFC/RFID transceiver chip 408 may generate NFC or RFID signals, which may be low-pass filtered by the LPF 412. The low-pass filtered NFC/RFID signals may be communicated via the resistor 404 and the LPF 420 to the NFC/RFID antenna 416 for transmission. The NFC/RFID coil or antenna 416 may be configured so that it may function as a ground plane for the BT/WLAN/ZIGBEE antenna 414. Accordingly, during transmission of the BT/WLAN/ZIGBEE signals, the NFC/RFID coil or antenna 416 operates as a ground plane to increase antenna efficiency of the integrated antenna module 250.

In accordance with an embodiment of the invention, once the NFC/RFID coil or antenna 416 is configured to function as a ground plane for the BT/WLAN/ZIGBEE antenna 414, the BT/WLAN/ZIGBEE antenna 414 may be utilized to receive FM and/or DVB-H signals.

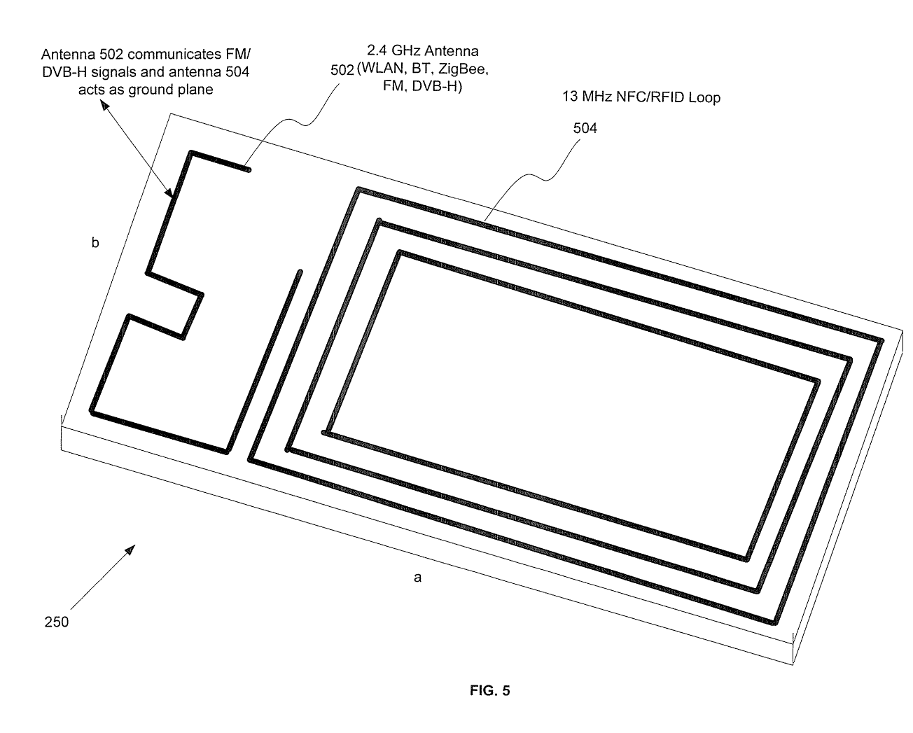

FIG. 5 is a block diagram of an integrated NFC and BT/WLAN/ZIGBEE antenna, in accordance with an embodiment of the invention. Referring to FIG. 5, there is shown the integrated antenna module 250 of FIG. 4. In one embodiment of the invention, the integrated antenna module may comprise a 2.4 GHz BT/WLAN/ZIGBEE antenna 502 and a 13 MHz NFC/RFID antenna 504. The 2.4 GHz BT/WLAN/ZIGBEE antenna 502 and a 13 MHz NFC/RFID antenna 504 may be implemented on a single substrate with dimensions a mm and b mm. In an exemplary embodiment of the invention, dimension a may be about 32 mm and dimension b may be about 14 mm. Other dimensions of the substrate may also be utilized.

In one embodiment of the invention, the NFC/RFID loop antenna 504 may be utilized for communicating FM signals. Furthermore, the NFC/RFID antenna 504 may be further modified by selecting and using one-half of the antenna loop of the NFC/RFID antenna 504 so that digital video broadcast-handheld (DVB-H) signals may be received and/or transmitted via the integrated antenna 250. Such modification of the antenna 504 may be achieved by shorting to ground one-half of the antenna loop of antenna 504 using, for example, a switch, an inductor, and a capacitor. An exemplary method and system for configuring an FM antenna to receive DVB-H signals is disclosed in U.S. application Ser. No. ______ (Attorney Docket No. 17788US01), which is incorporated herein by reference in its entirety.

In instances when the BT/WLAN/ZIGBEE antenna 502 is utilized to transmit BT or WLAN signals, the 13 MHz NFC/RFID/FM/DVB-H antenna 504 may be utilized as a ground plane for the 2.4 GHz BT/WLAN/ZIGBEE antenna 502. In this regard, the single integrated antenna 250 may be used for communicating different types of signals, such as BT, WLAN, NFC, RFID, FM, and/or DVB-H signals, while improving antenna transmit and receive characteristics by using the NFC/RFID/FM/DVB-H loop antenna 504 as a ground plane for the BT/WLAN/ZIGBEE antenna 502.

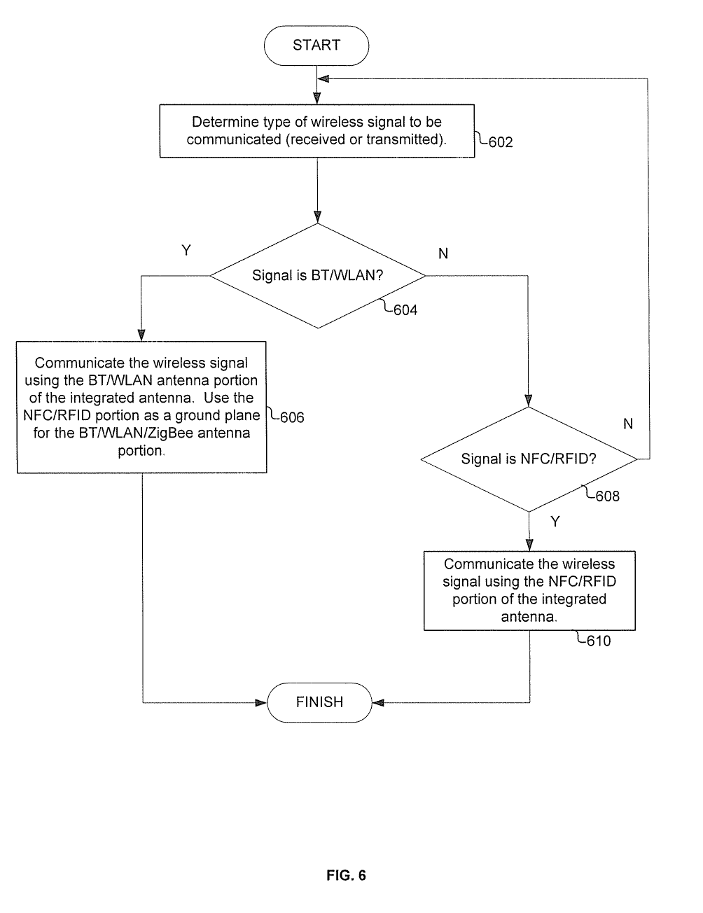

FIG. 6 is a flow diagram that illustrates an exemplary method for communicating wireless signals via an integrated frequency conversion in accordance with an embodiment of the invention. Referring to FIGS. 4 and 6, at 602, the transceiver module 402 may determine a type of wireless signal to be transmitted by the BT/WLAN/ZIGBEE and NFC/RFID transceiver chip 408. At 604, it may be determined whether the wireless signal to be transmitted comprises a BT/WLAN/ZIGBEE signal. If the wireless signal comprises a BT/WLAN/ZIGBEE signal, at 606, the BT/WLAN/ZIGBEE wireless signal may be transmitted via the BT/WLAN/ZIGBEE antenna 414 of the integrated antenna 250. The NFC/RFID antenna 416 may then be utilized as a ground plane for the BT/WLAN/ZIGBEE antenna 414 to increase antenna efficiency.

If the wireless signal does not comprise a BT/WLAN/ZIGBEE signal, at 608, it may be determined whether the wireless signal comprises a NFC/RFID signal. If the wireless signal does not comprise a NFC/RFID signal, processing may resume at step 602. If the wireless signal comprises a NFC/RFID signal, at 610, the NFC/RFID wireless signal may be communicated using the NFC/RFID antenna 416 of the integrated antenna 250.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for supporting wireless communication, the method comprising:
configuring a first antenna that communicates at least a first RF protocol signal so that said first antenna functions as a ground plane for a second antenna when communicating at least a second RF protocol signal via said second antenna.

2. The method according to claim 1, wherein said first antenna comprises at least one of: an NFC antenna and a RFID antenna.

3. The method according to claim 1, wherein said second antenna comprises at least one of: a wireless LAN (WLAN) antenna and a Bluetooth antenna.

4. The method according to claim 1, wherein said at least said first RF protocol signal comprises at least one of: a NFC signal and a RFID signal.

5. The method according to claim 1, wherein said at least said second RF protocol signal comprises at least one of: a Bluetooth signal and a Wireless LAN (WLAN) signal.

6. The method according to claim 1, comprising receiving at least a third RF protocol signal via said first antenna.

7. The method according to claim 6, wherein said third RF protocol signal comprises at least one of the following: an FM signal and a digital video broadcast handheld (DVB-H) signal.

8. The method according to claim 6, comprising reducing a length of said first antenna, if said third RF protocol signal comprises a DVB-H signal.

9. The method according to claim 6, comprising reducing a length of said first antenna in half utilizing a grounding circuit, if said third RF protocol signal comprises a DVB-H signal.

10. The method according to claim 9, wherein said grounding circuit comprises at least one of the following: a switch and a grounded L-C circuit.

11. A system for supporting wireless communication, the system comprising:
at least one processor that enables configuring of a first antenna that communicates at least a first RF protocol signal so that said first antenna functions as a ground plane for a second antenna when communicating at least a second RF protocol signal via said second antenna.

12. The system according to claim 11, wherein said first antenna comprises at least one of: an NFC antenna and a RFID antenna.

13. The system according to claim 11, wherein said second antenna comprises at least one of: a wireless LAN (WLAN) antenna and a Bluetooth antenna.

14. The system according to claim 11, wherein said at least said first RF protocol signal comprises at least one of: a NFC signal and a RFID signal.

15. The system according to claim 11, wherein said at least said second RF protocol signal comprises at least one of: a Bluetooth signal and a Wireless LAN (WLAN) signal.

16. The system according to claim 11, wherein said at least one processor enables receiving of at least a third RF protocol signal via said first antenna.

17. The system according to claim 16, wherein said third RF protocol signal comprises at least one of the following: an FM signal and a digital video broadcast handheld (DVB-H) signal.

18. The system according to claim 16, comprising reducing a length of said first antenna, if said third RF protocol signal comprises a DVB-H signal.

19. The system according to claim 16, wherein said at least one processor enables reducing of a length of said first antenna in half utilizing a grounding circuit, if said third RF protocol signal comprises a DVB-H signal.

20. The system according to claim 19, wherein said grounding circuit comprises at least one of the following: a switch and a grounded L-C circuit.
